(19) United States
(12) Patent Application Publication
(10) Pub. No.: US 2014/0067342 A1
(43) Pub. Date: Mar. 6, 2014

(54) PARTICLE TRACKING IN BIOLOGICAL SYSTEMS

(71) Applicant: Christopher P. Calderon, Denver, CO (US)

(72) Inventor: Christopher P. Calderon, Denver, CO (US)

(73) Assignee: Numerica Corporation, Loveland, CO (US)

(21) Appl. No.: 13/597,100

(22) Filed: Aug. 28, 2012

(51) Int. Cl. G06F 17/13

(52) U.S. Cl. 703/2

(57) ABSTRACT

A method of tracking and inferring the underlying dynamics of a tagged molecule in a living cell may include receiving an ordered data set of time-valued location observations of the molecule, dividing the data set into time windows, and assigning a stochastic differential equation (SDE) model to each of the time windows with a set of parameters. The method may also include fitting the SDE models assigned to each of the plurality of time windows using likelihood-based techniques, and determining an initial value for each parameter. The method may further include fitting the set of parameters for each of the SDE models using a nonlinear maximum likelihood estimation search, applying an optimization routine to generate a set of computed parameters, determining whether the computed parameters are valid using goodness-of-fit tests, and determining whether each of the SDE models is valid based on the goodness-of-fit-tests.

### BACKGROUND OF THE INVENTION

A biomolecule is any molecule that is produced by a living organism, including large macromolecules such as proteins, polysaccharides, lipids, and nucleic acids, as well as small molecules such as primary metabolites, secondary metabolites, and natural products. Living cells may contain hundreds of different biomolocules. Tracking biomolocules within living cells can be of interest to researchers.

Modern optical microscopes are able to create high resolution 3D measurements of individual biomolecule motion in living cells. The ability to track biomolecules at single-molecule resolution in their native environment permits researchers to address open questions in various fields including cell biology, nanotechnology, and virology. Current tools used to analyze data in these experiments often appeal to dynamical models. However, these dynamical models make questionable assumptions in order to simplify the necessary calculations. Unfortunately, reliable methods for checking the consistency of assumed models against experimental data are currently lacking, and the assumptions that are made can mask the complicated forces that affect biomolecule motion within a cell. Therefore, improvements are needed in the art.

### BRIEF SUMMARY OF THE INVENTION

In one embodiment, a method of tracking a tagged molecule in a living cell in two or three dimensions may be presented. The method may include receiving an ordered data set including a plurality of time-valued location observations of the molecule, and dividing the ordered data set into a plurality of time windows. The method may also include assigning a stochastic differential equation (SDE) model to each of the plurality of time windows, where each SDE model comprises a set of parameters. The method may additionally include fitting the SDE models assigned to each of the plurality of time windows using one or more likelihood-based techniques, and determining an initial value for each parameter in each set of parameters where the initial values are close to the global optimum for a nonlinear Maximum Likelihood Estimation (MLE) search. The method may further include fitting the set of parameters for each of the SDE models using the nonlinear MLE search, applying an optimization routine using the initial values to generate a set of computed parameters, and determining whether each of the computed parameters are valid using one or more goodness-of-fit tests. Finally, the method may also include determining whether each of the SDE models was valid based on the results of the goodness-of-fit tests.

In one embodiment the method may also include detecting the presence of model misspecification that is based on a window size of the plurality of time windows, and dividing the ordered data set into a second plurality of time windows. A second window size for the second plurality of time windows may be less the window size of the plurality of time windows. In one embodiment, each parameter in each set of parameters may be associated with a physical characteristic of either the molecule or an environment inside the living cell. In one embodiment, the molecule may be tagged such that the molecule emits a gradually changing fluorescent signature. In one embodiment, the plurality of time windows may include a first time window, and the SDE assigned to the first time window may include an overdamped Langevin equation. In another embodiment, the plurality of time windows may include a first time window, and the SDE assigned to the first time window may include a nonlinear SDE model. In one embodiment, the one or more goodness-of-fit tests may include a probability integral transformation (PIT). The optimization routine may include heuristics for inferring the global MLE and a nonlinear simplex search for determining the set of computed parameters. The goodness-of-fit tests can be used to identify potential local minima. In one embodiment, the plurality of time windows may include a first time window, the computed parameters for the first time window can be determined not to be valid, and the method may further include assigning a new SDE model to the first time window. The method may also include determining a trajectory of the molecule based on the computed parameters. The method may additionally include causing to be displayed on a display device, a 3D vector representation of forces affecting the motion of the molecule. In one embodiment, the one or more goodness-of-fit tests can be applied to each of an x, y, and z component of the molecule's position.

In another embodiment, a system including one or more processors and a memory may be presented. The memory may be communicatively coupled with and readable by the one or more processors and have stored therein a sequence of instructions which, when executed by the one or more processors, cause the one or more processors to track a tagged molecule in a living cell in two or three dimensions using operations including receiving an ordered data set comprising a plurality of time-valued location observations of the molecule. The one or more processors may further be instructed to divide the ordered data set into a plurality of time windows, assign a stochastic differential equation (SDE) model to each of the plurality of time windows where each SDE model comprises a set of parameters, fit the SDE models assigned to each of the plurality of time windows using one or more likelihood-based techniques, determine an initial value for each parameter in each set of parameters where the initial values are close to the global optimum for a nonlinear Maximum Likelihood Estimation (MLE) search, fit the set of parameters for each of the SDE models using the nonlinear MLE search, apply an optimization routine using the initial values to generate a set of computed parameters, determine whether each of the computed parameters are valid using one or more goodness-of-fit tests, and determine whether each of the SDE models was valid based on the results of the goodness-of-fit tests.

In yet another embodiment, a computer-readable memory may be presented. The computer-readable medium may have stored thereon a sequence of instructions which, when executed by one or more processors, causes the one or more processors to track a tagged molecule in a living cell in two or three dimensions by performing operations such as receiving an ordered data set comprising a plurality of time-valued location observations of the molecule. The one or more processors may further be instructed to divide the ordered data set into a plurality of time windows, assign a stochastic differential equation (SDE) model to each of the plurality of time windows where each SDE model comprises a set of parameters, fit the SDE models assigned to each of the plurality of time windows using one or more likelihood-based techniques, determine an initial value for each parameter in each set of parameters where the initial values are close to the global optimum for a nonlinear Maximum Likelihood Estimation (MLE) search, fit the set of parameters for each of the SDE models using the nonlinear MLE search, apply an optimization routine using the initial values to generate a set of computed parameters, determine whether each of the computed parameters are valid using one or more goodness-of-fit tests, and determine whether each of the SDE models was valid based on the results of the goodness-of-fit tests.

### BRIEF DESCRIPTION OF THE DRAWINGS

A further understanding of the nature and advantages of the present invention may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIGS. 1A-1C illustrate plots of examples of the entire noisily measured trajectory, according to one embodiment.

FIG. 2 illustrates the results for a particle experiencing smooth changes in the SDE parameters summarizing the dynamics inferred by the measurements, according to one embodiment.

FIG. 3 illustrates the estimated effective measurement noise associated with z versus time for seven different trajectories, according to one embodiment.

FIGS. 4A-4D illustrate a case where a particle interacts with an object in the cytoplasm of a living cell, according to one embodiment.

FIG. 5 illustrates the inferred forces for a molecule trajectory, according to one embodiment.

FIG. 6 illustrates flowchart of a method for tracking a particle, according to one embodiment.

FIG. 7 illustrates a block diagram illustrating components of an exemplary operating environment in which various embodiments of the present invention may be implemented, according to one embodiment.

FIG. 8 illustrates a block diagram illustrating an exemplary computer system in which embodiments of the present invention may be implemented, according to one embodiment.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Presented herein is a mathematical and computational framework for methods and systems that implement a new statistical inference algorithm that can be used to (1) reliably process the large collection of experimental trajectories generated by single particle tracking (SPT) experiments to assist in physically interpreting measurements taken of biomolecules in a living cell; and to (2) check the consistency of model assumptions against experimental data. These methods can help identify signatures of subtle molecular interactions in biophysical measurements that are not accounted for in models currently used in analyzing SPT data. Furthermore, the embodiments described herein can be used to create new dynamical models that more accurately summarize the diverse types of 3D forces and friction that a biomolecule can experience in living cells. In one exemplary embodiment, these methods can be used to study the 3D forces associated with mRNA motion in yeast cells.

The ability to track individual molecules in vivo with high resolution in three spatial dimensions (3D) offers new and exciting opportunities for quantitatively understanding the kinetics of individual biological molecules in their native environment. Quantifying the dynamics of a biomolecule within a cell is difficult because of the current inability to describe the constantly changing effective forces experienced by the molecule as it traverses a crowded and heterogeneous medium. Many unresolved questions remain regarding movement of biological macromolecules, such as what mechanisms are used to drive asymmetric mRNA localization, and how these mechanisms change over time as the particle travels through spatially distinct regions of a cell.

In standard SPT experiments, researchers generally take advantage of well-known methods for fluorescently tagging biomolecules in vivo. This creates signals that can be dynamically tracked in 3D using microscopy tools. These microscopy tools can be capable of overcoming previous resolution limitations imposed by visible light. The direct result is the dynamical measurement of individual, fluorescently tagged biomolecules, such as mRNA and proteins, in their native environment. In SPT experiments, researchers can measure the location of a point spread function (PSF) associated with the fluorescent emissions coming from the tagged biomolecules in order to estimate the biomolecule's position in the cell at a given time. However, at the time of this disclosure, there are many open questions associated with how to analyze and interpret the noisy sequence of time-ordered PSFs arising from these experiments. For example, it is not currently possible to make use of the noisy time series of tracked PSFs in order to infer how a tagged biomolecule is interacting with other molecules in the cell. Many other biomolecules can interact with the tagged biomolecule and influence its motion, but most of these interacting particles are untagged. The influence of untagged molecules on the tagged biomolecule can often only be quantified by effective forces and friction inferred from the PSF time series.

In order to infer models that have a biophysical interpretation, researchers must currently (1) make assumptions about the effective dynamical models and (2) develop schemes for estimating the parameters respecting the complex nature of effective thermal and measurement noise associated with the experimental data. For example, commonly used diffusion models computed via mean-squared displacement calculations implicitly assume that there is no systematic force acting on the particle, or that the systematic force has a constant magnitude for a relatively long time window. In mean-squared displacement calculations, linear regression methods are currently used to estimate parameters. Accounting for the effects of temporal correlation and measurement noise inherent in the time series has been discovered to be a problem plaguing this type of analysis.

Further complications are associated with the fact that the details of the numerous in vivo interactions induce substantial “heterogeneity” in the observed dynamics. No pair of trajectories is exactly alike, but researchers in biophysics and cell biology are interested in accurately quantifying/understanding this heterogeneity.

To address these and other deficiencies in the art, embodiments discussed herein use parameters that are calibrated using estimation techniques associated with likelihood-based time series inference methods. Assuming position-dependent forces allows a “dynamical map” to be constructed from the observed experimental trajectories. Other physically interpretable dynamical characteristics, such as elasticity and/or effective friction, can also be quantified by the assumed 3D models. Such information can be used to gain new insights into in vivo biological processes. For example, the effective forces experienced by the tagged particle can be inferred and plotted. Time-ordered position measurements can be plotted against inferred 3D force, which can suggest, for example, that the tagged mRNA may be binding with another biomolecule in the cytoplasm.

This disclosure will also demonstrate how “goodness-of-fit” testing tools from time series analysis can be used to check the consistency of stochastic model assumptions against high-resolution experimental data at single-molecule resolution (the latter feature allows for the detection and quantification of the heterogeneity previously mentioned). Goodness-of-fit testing not only permits researchers to have more confidence in parameters estimated from data, but it also allows researchers to identify trajectories whose dynamics violate assumptions implicit in simplified stochastic models.

In contrast to known methods, which focus on comparing the quality of two or more models, the embodiments describe herein also test all distributional assumptions implied by an assumed, or fitted, model against observed experimental data directly. It is entirely possible that all assumed models are inconsistent with observed measurements. In such a case, trusting the parameter estimates of the “best” model is questionable. In other words, the “best” model may still be so far off that it does not convey any useful information. Worse yet, a researcher may fail to uncover a physically interesting transient dynamical event that is implied by the data, but that is not accounted for in the assumed dynamical model(s).

In a particular embodiment, it may be demonstrated how using goodness-of-fit testing tools enable the discovery of interesting 3D mRNA trajectories measured in live yeast cells. For example, according to one set of observed data, 60 trajectories, each containing roughly 4,000 observations spaced 4 ms apart were analyzed. In all trajectories studied, it was observed that model parameters changed in a statistically significant fashion within single trajectories and between trajectories of different tagged mRNAs. The goodness-of-fit analysis employed identified trajectories violating SPT models commonly used in analyzing the parameters obtained from PSF time series. Using these results, it was discovered that new 3D models were required to accurately describe the effective forces experienced by the tagged mRNA particle as it traveled through the cytoplasm of a living cell. Coupling the 3D measurements with inferred Stochastic Differential Equation (SDE) forces allows new tools for studying putative molecular motor-induced transport and molecular binding in live cells.

Rigorous goodness-of-fit testing applied to microscopy trajectories has been problematic in the past due to technical difficulties and experimental resolution limitations. The embodiments described herein have been able to overcome these obstacles, and these embodiments can be applied in a high-throughput trajectory analysis identifying transient dynamical phenomena in live cell measurements. The embodiments described herein also illustrate the promise of extracting hidden dynamical information from the wide range of single-particle experiments now growing in importance in biological studies.

### Single Particle Tracking

The advances in microscopy that have enabled 3D in vivo cellular position measurements of biomolecules have led to an abundance of biologically relevant dynamical information contained in the trajectories has still not been utilized. Existing methods for analyzing trajectories suffer from information loss caused by coarse-grained mathematical models, or from an inability to overcome statistical challenges associated with noise inherent to in vivo measurements. SPT embodiments discussed herein may use time series analysis to estimate 3D SDE models of the underlying dynamics, and to construct hypothesis tests checking the consistency of a fitted model. The inferred SDE parameters can change in a statistically significant fashion over the duration of a single trajectory, presumably due to changes in sub-cellular micro-environment, thus statistical inference methods capable of checking all model assumptions using a single trajectory represented by a time series can be utilized. Tools providing quantitative descriptions of the effective forces experienced by a particle in a living cell can be used to generate new scientific hypotheses or can be used to check the consistency of predictions of proposed kinetic mechanisms with high-resolution experimental data.

Using these embodiments, one can infer a “force map” summarizing the 3D forces a tagged particle experiences in its native environment. Inferring the effective forces and verifying the consistency of a fitted dynamical model with experimental measurements provides useful quantitative information about dynamics occurring in living cells with single-molecule resolution. Further descriptions and examples of such force map are included below. Reliably quantifying the dynamics in multivariate data can be important to physical interpretation of various phenomena in live cell measurements.

Specifically, transition density (likelihood-based) time series methods can be merged with classical stochastic process ideas to both estimate and assess the statistical fit of stochastic differential equation (SDE) models calibrated from noisy experimental data. Consistency between experimental measurements and the various assumptions implicit to the fitted 3D models are checked via goodness-of-fit tests that are appropriate for non-stationary multivariate data exhibiting complex, and possibly nonlinear, spatial and temporal dynamics.

Furthermore, the methods presented can also be used to more precisely quantify dynamical regime changes along a single trajectory with less temporal averaging than methods currently used to analyze SPT data. In one embodiment, since only a single experimental trajectory is required for the statistical analysis (i.e., the goodness-of-fit tests can be applied on a trajectory-wise basis), the approach can be used for both quantifying dynamic heterogeneity and also identifying dynamic signature of transient events, such as molecular binding. As used herein, the term “dynamical heterogeneity” may refer to both (i) situations where kinetic parameters are substantially different between two or more trajectories, and (ii) situations where dynamical parameters change in a statistically significant fashion over the course of a single trajectory (e.g., the effective diffusion coefficient of one molecule changes by an amount substantially larger than the parameter uncertainty associated with the estimate).

Following a detailed discussion of various embodiments, experimental data from an ARG3 mRNA tracked in 3D in live Saccharomyces cerevisiae will be presented. This system was selected in part because only one or two copies of the mRNA are present in the cytoplasm at any given time, thus associating a fluorescent signal between different image frames measured by the microscope with a single molecule can be straightforward. The time series goodness-of-fit tests employed were applied to check the consistency of tracks formed by linear and nonlinear filters. For example, if a goodness-of-fit test applied to data used in forming candidate tracks finds an invalid model implicit to a filter (or conversely fails to reject a model) then the researcher could use this information in judging track/model quality by using experimental data directly without requiring simulations. Therefore, the basic approach shows promise in a variety of 2D and 3D SPT tracking applications. Thus, examples illustrating how the approach can be used to quantitatively probe complex dynamic interactions, such as binding and directed transport, occurring in a living cell are presented.

### The Stochastic Differential Equation Model

According to one embodiment, estimation and statistical inference problems such as an SPT problem can be represented with an SDE of the form:

drₜ=ΦF(rₜ)dt+\sqrt{2}σdBₜ (1)

ψtᵢ=rₜ_{ᵢ}+εₜ_{ᵢ} (2)

where the three dimensional position of the particle at time t is denoted by the vector rₜ≡(xₜ, y, zₜ)^{T}. The subscript t is used to index time in the stochastic process. In the SDE above, Bₜ represents a standard 3D Brownian motion process. The notation dBₜ is used to denote an Ito stochastic integral (similarly for drₜ).

The remaining terms (and their physical interpretations) in equation (1) and equation (2) will be described in greater detail after some additional notation is established, but briefly: F(rₜ) is a vector representing the force associated with rₜ; Φ is a matrix quantifying effective friction; and σ is related to a local diffusion coefficient. Stochastic effects inherent to SPT experiments, such as photon count uncertainty, prevent rₜ from being directly observed. The only quantity we can directly measure in the lab is denoted by ψ. This process is also indexed by time, e.g. ψₜ_{ᵢ}, but it can be assumed that measurements are only available at discrete time points. The random variable εₜ_{ᵢ} represents one 3D measurement noise realization at time tᵢ. The fitted SDE can be used to infer physical information about dynamical processes acting on the tagged particle. For example, F(rₜ) denotes the effective force acting on the particle implied by the observations. In other words, a quantity like F(rₜ) contains information about how the local cellular environment is affecting the tagged particle. The notation εₜ_{ᵢ}˜ [symbol] (0,R) can be used to convey that εₜ_{ᵢ} is assumed to be distributed according to a mean zero multivariate Gaussian with covariance R.

Rigorously quantifying measurement noise and testing the validity of distributional assumptions are both problematic using currently know methods and/or systems. Using an R inconsistent with the value associated with an experimental trajectory or assuming an incorrect measurement error distribution may bias parameter estimates of physically interesting quantities, such as F(rₜ). Motivated by these considerations, the inferred measurement noise from the observed data can be estimated using likelihood methods. In SPT applications, R is unknown a priori because the number of photons available for detection decreases during data collection. In other words, the fluorescent light emitted from the particle gradually decays after it is initially tagged. Furthermore, complex background fluorescence and other experimental artifacts make measurement noise difficult to predict and/or relate in a simple fashion to detected photons. Decoupling measurement noise from thermal noise inherent to all SPT trajectories is made possible by applying classic filtering along with modern SDE estimation and inference ideas applied to small scale biological systems, as will be described further below.

According to one embodiment, a specific model considered can include a linear SDE parameterized by a finite dimensional vector denoted by θ. The parameters contained in θ and the remaining terms in equation (1) and equation (2) can be defined by the following equations:

Φ=σσ^{T}/k_{B}T (3)

F(r)=A+Br (4)

σ=C (5)

ε˜ [symbol] (0,R) (6)

This collection of parameters to be estimated by the data can be denoted by δ≡(A,B,C,R). A can represent a 3D vector where Aε [symbol] ³. Additionally, B, C, and R can represent 3×3 real matrices. The equations above were inspired by models in statistical physics. For example, k_{B}T represents Boltzmann's constant multiplied by the system temperature. Also, it can be assumed that the inertia of the particle can be ignored through a fluctuation dissipation relationship stated in equation (3). In other words, the tagged particle can be considered to be in the “overdamped” regime. These various assumptions can later be checked via goodness-of-fit hypothesis testing. Equation (4) defines the parametric form of the effective local linear force experienced by the overdamped particle where B can be interpreted as an elasticity parameter. The instantaneous velocity of the overdamped particle is given by ΦF(rₜ).

Some of the SDE parameters approximating the dynamics or measurement statistics of the tagged particle change continuously with time in many SPT applications. Typically, the tagged particle measurement noise changes smoothly over the course of one trajectory. If it is assumed that there is a fixed constant measurement noise for the entire length of a modern SPT trajectory, this would be enough to cause model rejection by the goodness-of-fit hypothesis tests employed. Partially motivated by the fact that the measurement noise of each trajectory of the tagged particle changes with time in each trajectory, due, for example to “photobleaching” of labels, each trajectory can be subdivided into K blocks of contiguous time windows. In each window, the parameters of an SDE can be fit to each of the following time series:

{ψₜ_{ᵢ}}ᵢ₌ₙ_{₀}_{:0}ⁿ^{₁} (7)

{ψₜ_{ᵢ}}ᵢ₌ₙ_{₁}_{. . .} ⁿ^{₂} (8)

{ψₜ_{ᵢ}}ᵢ₌ₙ_{_{K−1}}ⁿ^{_{K}}^{:=N} (9)

The inferred information from a single trajectory is summarized in K parameter vectors: θ⁽¹⁾, θ⁽²⁾, . . . θ^{(K)}. In one embodiment, the value of the differences W≡(nᵢ₊₁−nᵢ)+1 representing the number of observations in a given local time window can be forced to be a constant value, and this constant can be denoted by W. The term “micro-time” can be used to refer to the times within local windows. For example, in “local time window 2” the observations {ψₜ_{ᵢ}}ᵢ₌ₙ_{₁}ⁿ^{₂} can be indexed by the micro-times tₙ_{₁}, tₙ_{₁}₊₁, . . . , tₙ_{₂}; the time-ordered sequence can be subsequently used to infer the SDE parameter vector θ⁽²⁾.

The 3D linear SDE model above can be fit via maximum likelihood methods using quantities associated with a Kalman filter. The concept of a Kalman filter will be well-understood by one having skill in the art. Prior to this disclosure, goodness-of-fit tests simultaneously checking all distributional assumptions, estimated parameter values, assumed parameter values, and/or the statistical dependence structure were difficult to rigorously address.

In some embodiments, the analysis can be restricted to the case where C and R are diagonal, representing uncorrelated thermal and measurement noise. F(r) can come from the gradient of a scalar potential, and therefore B can be symmetric. It should be noted that non-gradient forces and/or nonlinear multivariate SDEs can be considered in both estimation and inference. However, embodiments herein focus on the linear case to simplify exposition. The total number of parameters to estimate for each trajectory is 15 in the 3D SDE models considered. Estimation of the parameters in local window j is achieved by recording the measurements at W micro-times and using them to obtain the maximum likelihood estimate (MLE), which can be defined by:

$${\hat{θ}}^{( j )} = argmax 𝓁 ( {θ}^{( j )} ) ≡ {\sum }_{i = {n}_{j - 1} + 1}^{{n}_{j}} log ( p ( {ψ}_{{t}_{i}} \vert {ψ}_{{t}_{i - 1}} ; {θ}^{( j )} ) ) \qquad ( 10 )$$

where the parameter vector \hat{θ}^{(j)} can be the MLE assuming the initial measurement is precisely known. In some embodiments, finding the MLE may require an evaluation of the transition density, p(ψₜ_{ᵢ}|ψₜ_{_{i−1}}; θ^{(j)}). In the Kalman filter case described above, the transition density may be a multivariate Gaussian density.

Having described one basic structure of the method, we can now turn to a detailed description of the equations connecting the continuous-time SDE to the discrete Kalman filter, as well as the details of initial parameter guesses and goodness of fit statistics, according to one embodiment.

### Mapping SDEs to Kalman Filter Models

There are several embodiments, each using a different procedure for extracting the transition density from what is assumed to be a continuous-time, overdamped, Langevin equation. Accordingly, the Kalman filter equations that correspond to the discretely observed SDE considered herein are as follows:

rᵢ₊₁=A′+B′rᵢ+qᵢ₊₁ (11)

ψᵢ=rᵢ+εᵢ (12)

qᵢ₊₁˜ [symbol] (0,Q_{Δt}_{ᵢ}) (13)

εₜ˜ [symbol] (0,Rᵢ) (14)

where we define Δtᵢ:=tᵢ₊₁−tᵢ, B′:=exp(ΦBΔtᵢ), and A′:=−B⁻¹A+exp(ΦBΔtᵢ)B⁻¹A. The primes are used to indicate the discrete sample analogs that correspond to the continuous time SDE model. The covariance matrix Rᵢ characterizes the mean zero Gaussian noise associated with the measurement ψᵢ gathered at discrete time i.

The process noise covariance, Q_{Δt}_{ᵢ}, associated with the discretely sampled state can be computed from the corresponding continuous SDE. The process noise covariance of a discretely observed SDE in the general (non-stationary or stationary) multidimensional linear case is given by:

Q_{Δt}_{ᵢ}:=∫₀^{Δt}2exp(ΦBs)CC^{T}exp((ΦB)^{T}s)ds (15)

where the subscript on Q can be used to emphasize the dependence on the time between successive observations. In one embodiment, all exponentials can be interpreted as matrix exponentials. The integral in equation (15) can be solved exactly by using established tools that would be readily understood by one having ordinary skill in the art of control theory. These equations have been written for cases where data is uniformly sampled Δtᵢ time units apart. However, the arbitrary time spacing cases can also be readily obtained. The quantities above can be used for both filtering (inferring the unobservable rₜ given ψₜ) or for estimating unknown parameters. The expression in equation (15) can simply be plugged into equations that are commonly used in time series analysis.

Note that if the linear model above is consistent with the model and the initial conditions are precisely known, then the unobservable state is a multivariate Gaussian process. This idealized process is completely statistically characterized by its first two moments. Therefore, if the measurements are also Gaussian, then computing the likelihood of the observations ψₜ only requires the mean and covariance of a sequence of Gaussian random variables, which are often called the “innovations”. In one embodiment, computing the innovations requires iterating the Kalman filter. After Q_{Δt}_{ᵢ} is computed, this is a fairly straightforward process for one having skill in the art.

The above discussion is for general linear equations. However, to illustrate tools familiar to researchers in statistical physics, a special case is presented where the eigenvalues of B are all real and negative. This characterizes a case implicitly assumed by common models such as a corralled diffusion model. The mean computed under this special case assumption is the same as the more general case (for finite Δt). However, the covariance computation simplifies stationary distribution (or “steady state”) formulas that are used from statistical physics. Knowledge of the stationary distribution allows the following compact expression for the conditional (multivariate normal) distribution of the underlying state:

rᵢ˜ [symbol] (μᵢ,Q_{Δt}_{ᵢ}) (16)

μᵢ=−B⁻¹A+exp(ΦBΔtᵢ)(rᵢ₋₁+B⁻¹A) (17)

Q_{Δt}_{ᵢ}=Λ−exp(ΦBΔtᵢ)Λexp((ΦB)^{T}Δtᵢ) (18)

Δtᵢ=tᵢ−tᵢ₋₁ (19)

where Λ is the stationary covariance density associated with a given “stable” linear SDE. Expressions for Λ under various models/conditions will be well known to those having ordinary skill in the art.

Alternatively, the solution for more general linear models can be obtained by solving for the steady state solution of the Riccati matrix equations where terms involving the measurement noise are set to zero. The utility of the above expression is that the conditional mean and variance of the state can be utilized by the Kalman filter to compute the likelihood function of the innovation sequence. The Kalman filter can then provide p(ψᵢ₊₁|ψᵢ; θ) using the mapping between continuous SDEs and discrete Gaussian time series described above.

### Generating Initial Conditions

Generating the initial conditions for a 3D SDE MLE search can, at least in principle, be found by simply optimizing equation (1). However, it is often both practically and theoretically useful to have a procedure for systematically generating reasonable initial guesses to the parameters before a non-linear MLE search is attempted. One computational complication encountered when estimating an SDE is that the algorithm can get stuck in a local minimum of the likelihood function that is not the MLE. Fortunately, the goodness of fit tests discussed below can help identify this problem. Identifying a poor fit is helpful, but rejection can occur either because the algorithm is stuck in a local minimum or because the assumed model (with the global MLE parameter computed exactly) is inconsistent with the observations. If the model for the given data is rejected, but there is a reliable procedure was used to generate reasonable initial guesses for the model, then it is much more likely that the rejection is due to poor modeling assumptions, rather than being stuck in a local minimum.

According to one embodiment, a procedure for generating initial conditions for the overdamped Langevin SDE is presented. It should be noted, that within each local window, the time averaged measurement vector can be subtracted from all observation in that window (i.e. the resulting data analyzed has a mean of exactly zero). This may be done to simplify interpretation of the parameters. For example, when the mean is subtracted, the parameter A may correspond to the force at the average position.

First, an embodiment for generating initial estimates of the thermal and measurement noise will be described. One advantage of assuming an SDE like that given in equation (1) is that the effects of thermal and measurement noise can readily be estimated in the time domain if one has frequently sampled data. The process can begin by estimating a directed diffusion model of the form rₜ_{ᵢ₊₁}=rₜ_{ᵢ}+(tᵢ₊₁−tᵢ)v+η from noisy measurements ψₜ_{ᵢ}=rₜ_{_{i+ε}}ₜ_{ᵢ} where v is the constant velocity vector and η is a Gaussian random variable with mean zero and variance σ². The classic directed diffusion model makes it possible to separately estimate an MLE parameter for each component of r=(x, y, z). The parameters associated with x are θ=(vₓ, Rₓ, σₓ), and these are assumed to be statistically independent of the corresponding y and z parameters. The more general multivariate case that allows for correlated diffusive noise can also be readily handled, but this discussion will focus on the scalar case to facilitate exposition. The term Δt can be used to denote the uniform time sampling rate used herein. However, it should be noted that the methods presented do not require uniform temporal sampling in order to obtain exact likelihood expressions, particularly for other super-resolution or quantum dot applications. If the observations are consistent with the model and the parameters are known, then the transition density corresponding to {ψₜ_{ᵢ}−ψₜ_{_{i−1}}−Δtv}ᵢ₌₁ⁿ^{ⱼ}≡{Δψₜ_{ᵢ}−Δtv}ᵢ₌₁ⁿ^{ⱼ} is a multivariate Gaussian with mean zero and covariance:

$$C ≡ ( \begin{matrix}{σ}^{2} Δ t + 2 R & - R & 0 & … & … & 0 \\ - R & {σ}^{2} Δ t + 2 R & - R & ⋱ & ⋱ & 0 \\ 0 & - R & {σ}^{2} Δ t + 2 R & ⋱ & ⋱ & 0 \\ ⋮ & ⋱ & ⋱ & ⋱ & ⋱ & - R \\ 0 & 0 & 0 & … & - R & {σ}^{2} Δ t + 2 R\end{matrix} ) \qquad ( 20 )$$

The eigenvalues and eigenvectors of the above matrix can be computed analytically because the matrix above can be written as the sum of the identity matrix multiplied by σ²Δt minus the second difference operator matrix multiplied by the scalar R. Eigenvalue i of the latter matrix is given by 4R sin

$$( \frac{π i}{2 ( {n}_{j} + 1 )} ) ,$$

so therefore eigenvalue i of the above matrix is simply σ²Δt+4R sin²

$$( \frac{π i}{2 ( {n}_{j} + 1 )} ) .$$

The eigenvectors can also easily be computed with a compact expression (and hence C⁻¹ can be explicitly constructed), but one only needs to evaluate the logarithm of the determinant of C (which only requires eigenvalues) and V^{T}C⁻¹V, where V denotes a column vector containing each of the observations {Δψₜ_{ᵢ}−Δtv}ᵢ₌₁ⁿ^{ⱼ}, in order to evaluate the likelihood function. In one embodiment, the tridiagonal structure can be exploited by sparse matrix solvers in order to efficiently evaluate the likelihood function instead of forming the exact matrix inverse, which is dense. Doing so can save substantial time if many long SPT trajectories are being analyzed.

A quasi-likelihood analysis of the above model has some nice statistical properties. The utility of these properties in regards to SPT applications will be discussed further below. After finding the MLE (or quasi-MLE) of the model discussed here for each component, the two diagonal matrices \tilde{R} and \tilde{C} can each be formed. Each of \tilde{R} and \tilde{C} contains the output of the noise parameters of the directed diffusion model on the diagonals. The velocity parameter can be used to provide an initial guess to the vector Ã. Tildes are used to denote the initial guesses formed using the procedure outlined here. Also note that colored parameter vectors were not used in order to emphasize that the estimated parameters above are scalars (the vectors and matrices are formed by merging the x, y, z results).

Next, the initial estimates of the B matrix can be generated. There are a variety of approaches can be considered for estimating the matrix B associated with equation (4). The approach of one embodiment utilizes the well-known Riccati matrix equations to generate initial guesses. This embodiment also utilizes some tools associated with the continuous Kalman filter. An explicit relationship between the continuous SDE parameters and the discrete Kalman filter equations can be established that is useful in explicitly constructing the likelihood function used for estimation and inference of the SDE models considered. However, the continuous Kalman filter equation are adequate for one method of generating initial guesses of the B matrix. Recall that in the models under consideration, the force is assumed to come from the gradient of a potential, thus B is a symmetric matrix. The relevant Riccati equations are given by:

\dot{P}≡γP+Pγ^{T}+Q−PR⁻¹P (21)

0=γPₛₛ+Pₛₛγ^{T}+Q−PₛₛR⁻¹Pₛₛ (22)

In these equations, P is the covariance associated with the Kalman filter, γ is a matrix related to the SDE parameter B of interest, namely γ≡ΦB≡CC^{T}B/(k_{B}T), Q is the instantaneous covariance of the process noise in the uniform time spacing case equal to 2CC^{T}, R is the covariance of the measurement noise, and Pₛₛ is the filter covariance reached at steady state.

In order to estimate Q and R, an estimator that is well known in the art of financial analysis can be used. In one embodiment, the estimator described in High-Frequency Covariance Estimates with Noisy and Asynchronous Financial Data, by A\dot{i}t-Sahalia, Fan, and Xiu (2010) Journal of the American Statistical Association 105:1504-1517 can be used, except that the constant directed diffusion parameter A in the model can be used in addition to noise estimates. Recall that in all cases, the empirical mean of the measurements in window j can be computed. This quantity can be denoted by û^{j}, and can be subtracted from the measurements in window j. To estimate Pₛₛ, the empirical covariance of the measurements in a local window j can be computed. Denote this empirical covariance by Ĉô\hat{v} ({ψᵢ}ᵢ₌₀^{nj}). In the models considered, this empirical covariance can be used to provide an estimate of Pₛₛ, denoted as \tilde{P}ₛₛ using the equation Pₛₛ=Ĉô\hat{v} ({ψᵢ}ᵢ₌₀^{nj})−\hat{R}. Established matrix methods can then be utilized by plugging in \tilde{Q}=2\tilde{C}\tilde{C}^{T}, defining γ=\tilde{C}\tilde{C}^{T}\tilde{B}/(k_{B}T), and solving the transpose of equation (22) for the symmetric \tilde{B} by replacing the estimates denoted by tildes for their analogs without tildes appearing in equation (22).

For discrete observations, a heuristic that has been found to be useful is to compute \tilde{P}ₛₛ as before, but solve the Riccati equation by omitting any terms including R. The estimated \tilde{P}ₛₛ attempts to remove measurement noise effects and back out the “steady state” covariance. In either case where R is including or ignored in the Riccati equation, well established linear algebra tools can be used for this computation. Such tools can exploit the symmetric nature of B. The symmetric case considered can also be used to generate initial conditions for more general models, such as those having forces not coming from the gradient of a potential. These initial estimates denoted by the tilde version of the model parameters can then be used to start optimization search for the MLE parameters.

The practical and theoretical utility of assuming a stationary filter covariance is admittedly questionable in some scenarios. For this reason, it is suggested that other estimates of B also be used. For example, an estimate could be derived by setting all of the quantities in the matrix to zero. Alternatively, a linear SDE MLE parameter could be used that ignores measurement noise altogether to generate other candidate initial guesses that do not appeal to this type of assumption. Additionally, the mathematical conditions guaranteeing that the parameter vector is uniquely identifiable in 3D SDE estimation are nontrivial. Even if the observed data follows the assumed model and the parameter is identifiable, the global optimal parameter may need to be carefully found in a nonlinear MLE search.

### Qualitative Description of the Goodness-of-Fit Tests

The Kalman filter has been extensively utilized in control and estimation. However, rigorous statistical methods for analyzing the goodness of fit of the model have been lacking. If the unobservable state and observed measurement data is consistent with the assumed SDE and measurement model, then the normalized “innovation sequence” is independent and identically distributed (i.i.d.). Furthermore, the distribution of the normalized innovation sequence follows a multivariate Gaussian distribution characterized by a mean of zero and an identity matrix as the covariance. This statistical properties can be used for filter tuning (i.e., parameter estimation), but hypothesis testing methods which can reliably and jointly check the independence and the standard normal distribution assumption along a single trajectory have only recently been developed.

In this section, the basic idea behind the goodness of fit approach used by some embodiments is presented in a descriptive fashion using a so-called directed diffusion model. This is but one of many models that may be fit to observed data within a time window. One example used to illustrate the basic idea behind the method is the following: if a tagged particle is subjected to random thermal forces which can be modeled by a Brownian motion process, and measurement noise does not contaminate the observational data, then a directed diffusion model would state rₜ_{ᵢ₊₁}=rₜ_{ᵢ}+(tᵢ₊₁−tᵢ)v+η where again, v is the constant velocity vector and η is a Gaussian random variable with mean zero and variance σ². If this model is consistent with the data and the parameters are precisely known the series {ψₜ_{ᵢ} }ᵢ₌₀^{N} (which equals {rₜ_{ᵢ}}ᵢ₌₀^{N} because measurement noise is assumed to be nonexistent) can be transformed to {vₜ_{ᵢ}}ᵢ₌₀^{N} where vₜ_{ᵢ}=(rₜ_{ᵢ}−rₜ_{_{i−1}}−(tᵢ₊₁−tᵢ)v)/σ. One advantage of embodiments using this procedure is that a non-stationary time series can be transformed into a sequence of i.i.d. random variables {vₜ_{ᵢ}}ᵢ₌₀^{N} having a standard normal distribution if the assumed model is consistent with the measurements and the directed diffusion model parameters are precisely known. Time series methods can be used to systematically jointly test both the distribution of the transformed variables and the independence assumption. In one embodiment, this can be accomplished by transforming the v series into a suitable test statistic.

Although the transformation shown here is trivial for the directed diffusion model, as it only requires evaluating the cumulative distribution function of standard normal random variable evaluated at vₜ_{ᵢ}, noisily measured nonlinear Markovian SDEs can also be transformed into a “generalized residual” series by introducing the probability integral transformation (PIT), or Rosenblatt transformation, defined by Zₜ_{ᵢ}≡∫_{-∞}^{ψt}^{ᵢ}p(ψ|ψₜ_{_{i−1}}; θ)dψ. After the generalized residuals are formed, an “omnibus” Q-test can be used to test if all known statistical properties of the PIT sequence hold. In addition, the M-tests discussed further below can be used for a subset of the statistical properties that should hold in the PIT sequence. The Q-tests can be considered “omnibus” in the sense they check for every possible model misspecification. However, this comes at the expense of power, i.e., the method may fail to reject an incorrect model because it is checking too many features simultaneously. Although the M-test does not check the uniform distribution shape, it is useful in detecting statistical dependence induced by dynamical features in the data not accounted for in the models considered. Both tests can be applied to the innovations of a Kalman filter whose parameters are calibrated from data.

### Mathematical Description of the Goodness-of-Fit Tests

Turning now to the mathematical details of the goodness-of-fit hypothesis tests and model selection criteria, evolution and measurement equation are often completely characterized by the parameter vector θ and typically implicitly account for noise in r and/or ψ. It should be emphasized that the basic Kalman filter's optimal state estimate may require the state to follow the assumed linear dynamics and may also require precise knowledge of the “true” θ. In practice, this parameter needs to be estimated from data, and this estimate can be denoted by \hat{θ}. In addition to uncertainty in the “true” θ, i.e. uncertainty in \hat{θ} due to the sample sized used to obtain the estimate, the fundamental assumption of linear dynamics can be questionable.

The PIT transformation of a correctly specified model has a known distribution U [0,1], and each observation is statistically independent of the other observations. This condition does not require resorting to asymptotic arguments, so hypothesis tests can be established which simultaneously check if the transformed Zᵢ's are statistically independent and have the U [0,1] shape. Deviance from either condition suggests the approximating model is too simple. The so-called “omnibus” Q test statistic from equation (24) described below can jointly check both the i.i.d. and U[0,1] shape assumption.

However, if one is more concerned with model misspecification errors are influencing future predictions and/or understanding the nature of modeling errors, then the M-test may prove more useful. The M-test does not check for the U[0,1] shape of the PIT transformation, but instead focuses on autocorrelations in the Zᵢ's. In the case of a Kalman filter, the M-test is fairly similar to analyzing only the autocorrelation function of the innovations; however, the method analyzes the PIT (or generalized residuals) and can be used with nonlinear and/or non-Gaussian dynamical models where a likelihood function is available. The M-test can also detect such features in data where linear models are assumed whereas classic Kalman filter diagnostics fail. The M-test is also useful as a diagnostic tool because it utilizes all moments of an assumed (nonlinear) dynamical model as opposed to just analyzing the first two moments. Tools of this sort will be helpful in assessing cases that use simplified sensor models for observational data.

It should be noted that for general multidimensional processes, there are open questions and issues associated with marginalizing and forming of the PIT sequence. The 1D goodness of fit tests can be formed according to known techniques. For the multivariate linear cases, the PIT can be applied to the sequence of normalized innovations that are formed by applying the matrix square root of the filter covariance to the innovation vector at each time. For a correctly specified model, the latter sequence is i.i.d. normal if the Kalman filter model is consistent with the observations, so the PIT associated with this transformed sequence can be readily formed as in the scalar case, except that the length of the PIT series now increases by a factor of three. By applying analysis techniques (such as those described in Nonparametric specification testing for continuous-time models with applications to term structure of interest rates, by Hong and Li (2005) Rev. Fin. Studies 18:37-84) to the normalized residuals, some of the technical problems known to exist with multivariate versions of the test can be bypassed. In the 3D case, the longer 1D PIT sequence was formed by interweaving the PIT computed using the normalized 3D innovation vector. For example, at each time, the method alternated between recording the innovation in the x, y, and z positions. “Stacking” was also explored, where all PITs computed using the normalized x innovations were placed in the order of the corresponding temporal observation, followed by all of those PITs computed using normalized y innovations, and so forth.

The test statistic results obtained were not very different in either case. The Gaussian nature and i.i.d. property of the normalized innovations overcomes some of the complications of multivariate PIT time series analysis. This holds if the data generating process is Gaussian and has a correctly specified linear state and measurement equation However, if the underlying data generating process is outside of the linear Gaussian class, extensions of other recent multivariate goodness of fit methods for non-stationary SPT signals also show promise. Interesting trajectories were discovered when the 1D analog of the SDE models were strongly rejected along several windows of a 3D trajectory. Again, in 1D, PIT based methods have been shown to exhibit favorable power in many situations. Situations have occurred where the PIT based method is shown to be able to detect 3D interactions with reasonable power using the approach discussed above.

After the parameters of the SDE are estimated, the raw data can be used to compute the PIT sequence using the methods stated above. The i.i.d. U[0,1] property holds at the exact data generating process. In practice, an MLE \hat{θ} can be plugged in, and the SDE model structure can be used along with the observations to compute the N Zₖ's, where N is the total number of PIT entries associated with one 3D trajectory. N may be larger than the number of time series entries in the multivariate case and equal W in the 1D case. This sequence can then be used to compute the following quantities, namely:

$$\begin{matrix}\hat{M} ( m , l ) ≡ ( {\sum }_{j = 1}^{N - 1} {w}^{2} ( \frac{j}{p} ) ( N - j ) {\hat{ρ}}_{ml}^{2} ( j ) - {\sum }_{j = 1}^{N - 1} {w}^{2} ( \frac{j}{p} ) ) / {( 2 {\sum }_{j = 1}^{N - 2} {w}^{4} ( \frac{j}{p} ) )}^{\frac{1}{2}} & ( 23 ) \\ \hat{Q} ( j ) ≡ ( h ( N - j ) \hat{I} ( j ) - {hA}^{0} ) / {V}_{0}^{2} & ( 24 ) \\ \hat{I} ( j ) ≡ {\int }_{0}^{1} {\int }_{0}^{1} {( {\hat{g}}_{j} ( {Z}_{1} , {Z}_{2} ) - 1 )}^{2} d {Z}_{1} d {Z}_{2} & ( 25 ) \\ {\hat{g}}_{j} ( {Z}_{1} , {Z}_{2} ) ≡ \frac{1}{N - j} {\sum }_{n = j + 1}^{N} {K}_{h} ( {Z}_{1} , {\hat{Z}}_{n} ) {K}_{h} ( {Z}_{2} , {\hat{Z}}_{n - j} ) & ( 26 )\end{matrix}$$

The terms appearing in equations (23)-(26) will be understood by one having skill in the art, and can be derived, for example, as shown in Hong and Li, supra. The essence of the above two test statistics can be understood by noting that h is a bandwidth used along with a specialized nonparametric kernel function Kₕ(·,·) aiming to estimate a U [0,1] distribution on the square taking into account boundary effects given a finite set of observations and N is the number entries in the observed time series. In the definition of Q, j is a user specified index that selects the spacing between the \hat{Z}ₙ's (a value of j=1 can be used). In the definition of \hat{M}, \hat{ρ}ₘₗ(j) denotes the sample cross correlation between \hat{Z}ₙ^{m}, \hat{Z}_{n-|j|}^{l} where stationarity is assumed and w(·) is the Bartlett kernel. Note that in \hat{M}(m, l), the data selects j, but one may need to specify the integer parameters m and l.

Model selection should also be considered in addition to goodness of fit. The Akaike information criterion (AIC) and Bayesian information criterion (BIC) are classic methods for selecting models that will be readily understood by one having skill in the art. Each penalizes model complexity in a different fashion, namely AIC=−2l(\hat{θ})+2 k and BIC=−2l(\hat{θ})+k log(N) where k represents the number of components in \hat{θ} and N is the number of observations used to compute the MLE parameter estimate. Lower values denote a more preferable model.

### Example SPT Data

Generally, a time ordered image stack may be collected where consecutive images are measured at a regular time interval, such as every 4 ms. The time ordered image stack can then be used to generate each SPT trajectory. For example, in testing one embodiment, 60 ARG3 mRNA trajectories were analyzed in total with a 4 ms sampling period. 3D measurements were obtained by analyzing a double-helix point spread function (DH-PSF) in each image. The mRNA trajectory extracted from the image stack was divided into contiguous windows each containing W=400 noisy 3D observations. The number of contiguous observations was determined to provide a balance between variance and bias. The results reported were not found to depend on the window size or the temporal sampling rate. Using W=400 resulted in a total of 473 windows of 3D data. Individual single particle trajectories were associated with K=4−12 blocks of local window data. The length of data associated with one trajectory depended stochastically on photobleaching effects.

Initially, it was assumed that the three position coordinates evolved statistically independent of one another when estimating the SDE parameters in the 473 windows of 3D data. The assumption of statistical independence of the position coordinates effectively increased the number of 1D SDE parameter vectors estimated to 1419=3×473. After fitting models to observed experimental data, two test statistics were computed. First, the omnibus “Q-test” discussed above, which simultaneously checks the distributional shape and the statistical dependence in the PIT. Second, the “M-test” was computed, which focuses only on statistical dependence in the computed PIT sequence. More specifically, the M-test used was M(1,1) with a lag truncation parameter of 20.

In this study, results obtained using M(i,j) were similar for i,jε{1,2} and lag parameters of 10 and 30. Sampling parameters j=1 and p=20 were used to construct the Q test statistic. More specifically, the M and Q test results were effectively independent of sampling parameters. In this data set, 136 out of 1419 1D SDE models were rejected by the Q-test and 290 of 1419 were rejected by the M-test. After further inspection of the rejected cases, it was found that several trajectories where 1D SDE models assuming independently evolving coordinates were rejected exhibited rich dynamics that will be shown below. Of the trajectories rejected, inclusion of a 3D force permitting coupling between the (x, y, z) forces in the SDE improved the fit in terms of the AIC and BIC model selection criteria and goodness-of-fit. The AIC and BIC model selection criteria attempt to quantitatively balance “predictive power” against model complexity.

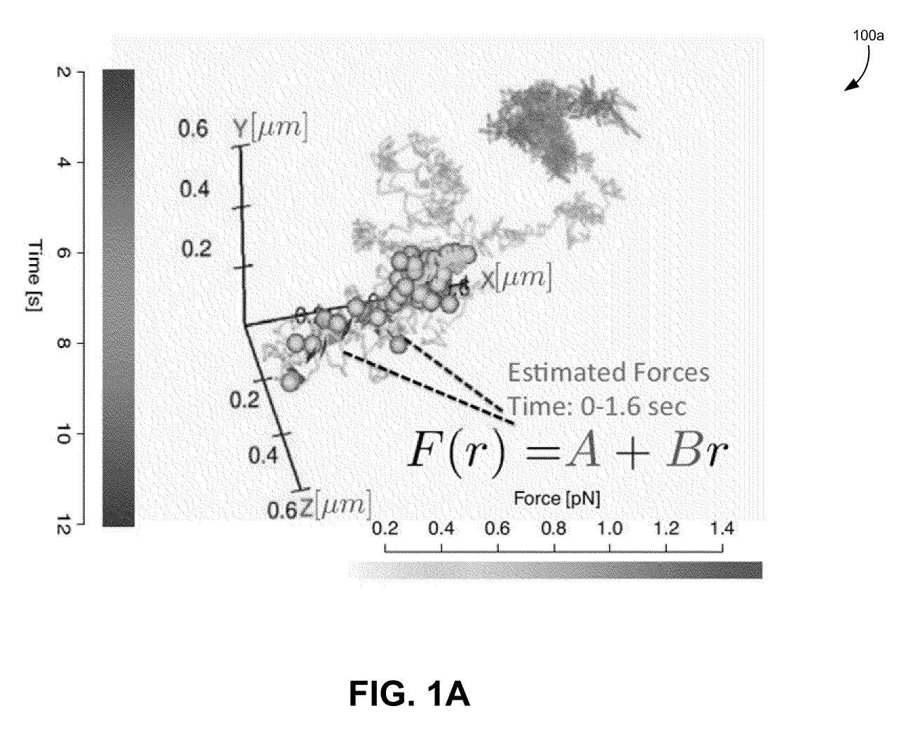

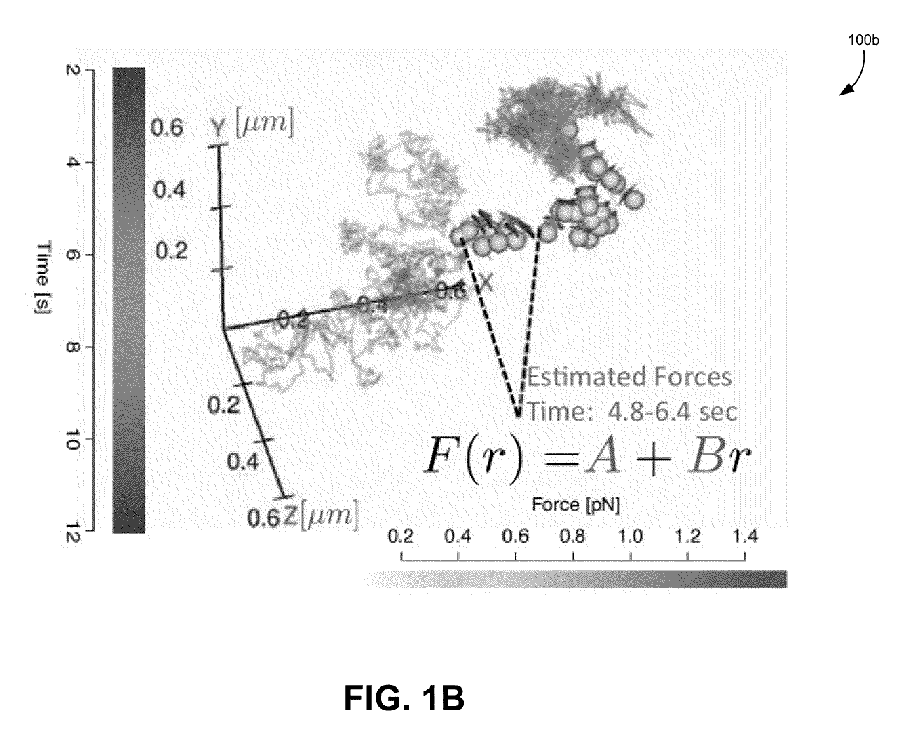

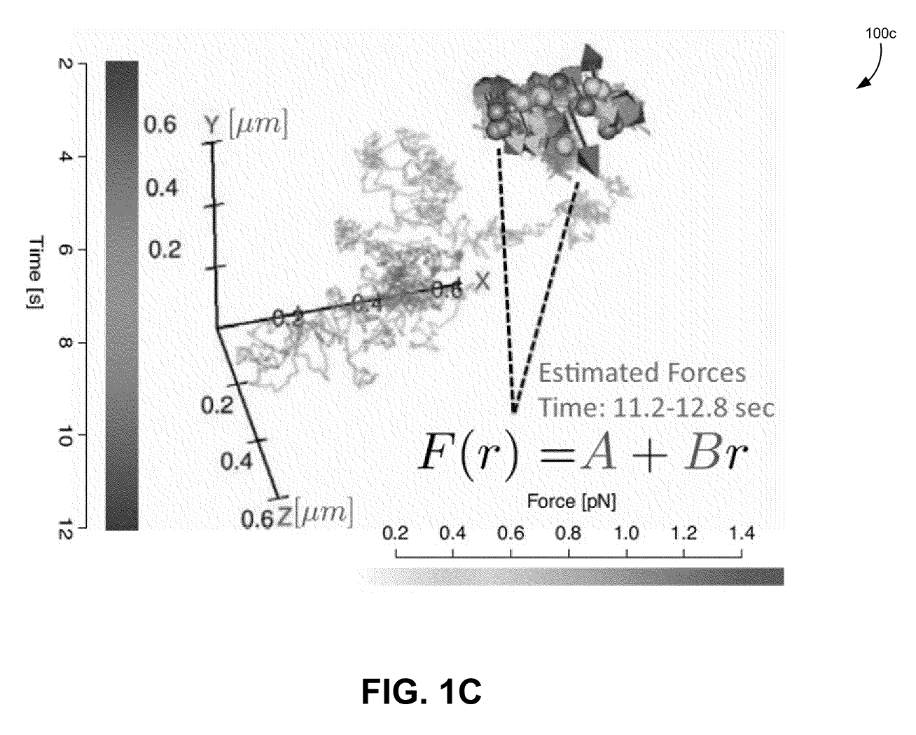

First, the case is considered where the assumption of statistical independence between the coordinates is not rejected by the goodness-of-fit tests. This case illustrates the type of information that these embodiments can extract from a single trajectory when standard SPT models are consistent with the data used for estimation. FIGS. 1A-1C illustrate plots of examples where the entire noisily measured trajectory (containing both thermal and measurement noise) is represented. Superimposed on each plot are the inferred forces at different micro-times, which are plotted as arrows in each plot.

It is possible that a single tagged particle tracked for a long enough time can exhibit a dynamical regime change. For example, the particle can change from exhibiting “pure” diffusion to one consistent with another mode of motion such as “directed motion” or “corralled/confined” diffusion. These types of regime changes can be clearly observed in the single trajectory of FIGS. 1A-1C. The change between the two regimes is relatively smooth and slow relative to the temporal sampling frequency. These force vectors provide a type of “dynamical map” of the cellular environment augmenting the position data and quantify how the particle is interacting with other molecules in the cell.

Specifically, FIG. 1A illustrates a single mRNA trajectory for first time window. The plot 100a represents a full 3-D trajectory as a solid line. The inferred force vectors corresponding to a time segment are plotted. These forces were obtained by first estimating the SDE parameters in the window, and then using the measurements to evaluate the force present at several micro-times in the local time window. The plot in FIG. 1A corresponds to a first time window that could be labeled as a “pure diffusion” type of motion.

The plot 100b in FIG. 1B corresponds to a second time window where there is a transient regime that would not fall into any classical single particle tracking type of motion. Conversely, the plot 100c in FIG. 1C corresponds to a third time window that could be labeled as “confined/corralled” motion. The inferred force vectors in the plots of FIGS. 1A-1C can be estimated from the observed time series without using an external force probe. The magnitude and direction of these force arrows can help identify the inward facing forces experienced by the confined particle.

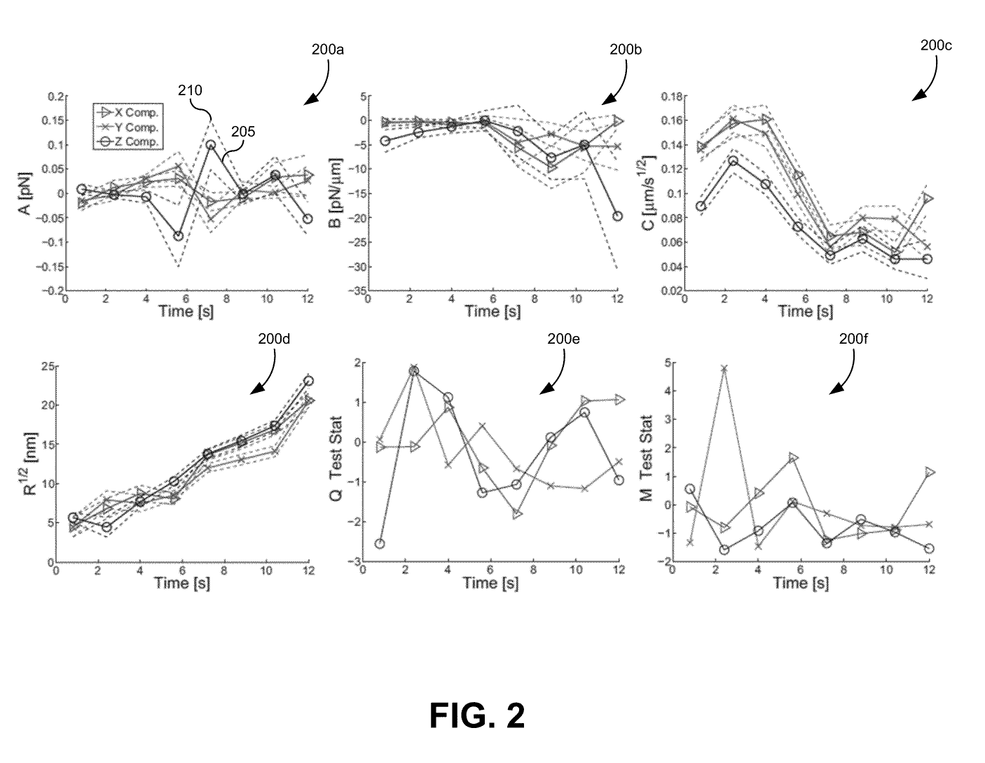

FIG. 2 illustrates the results for a particle experiencing smooth changes in the SDE parameters summarizing the dynamics inferred by the measurements. The parameters of the local SDEs estimated from experimental data in each time window are plotted as symbols in plots 200a through 200f. The solid lines 205 connect the parameters estimated in the different plots. The dashed lines 210 correspond to the standard deviation, or parameter uncertainty, associated with a simulated SDE processing the same parameters as those observed for the experimental data. Of particular note is how the parameter values change slowly as time evolves.

In plot 200a, the estimated A parameter is plotted versus time. There are three sets of curves associated with a given 3D trajectory, one for each spatial dimension. The confidence bands were obtained by Monte Carlo simulation of an idealized SDE containing the same parameters as those estimated from the experimental data. These confidence bands are shown to indicate how much the model parameters need to change in order to be considered statistically significant. Plot 200b, plot 200c, and plot 200d are similar except they correspond to the parameters B, C, and R, respectively.

Plot 200e and plot 200f plot the Q and M goodness-of-fit statistics associated with the observed data and the estimated θ^{(j)}. These plots more quantitatively demonstrate that the change in dynamical responses is not instantaneous on timescales now resolvable in single-molecule experiments, i.e. a pure diffusion continuously morphs into a corralled diffusion. It should be noted that these results are for a case where traditional SPT models were not rejected, and hence the off-diagonal terms in B are 0.

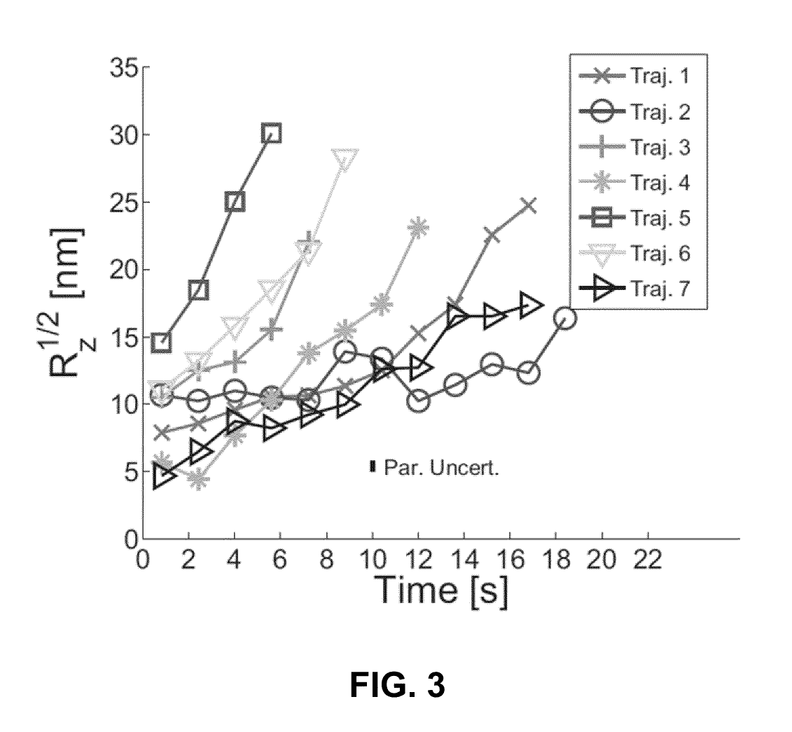

SDEs with smoothly evolving parameters was a feature common to all SPT trajectories analyzed. In all cases, the effective measurement noise was observed to smoothly vary over the course of data collection and the change within individual trajectories was statistically significant. FIG. 3 illustrates the estimated effective measurement noise associated with z versus time for seven different trajectories. Note how both the general shape—not just slope and intercept—vary between different trajectories. The non-trivial trend in effective measurement noise is due in part to trajectory-specific background fluorescence, differing numbers of active emitters, and other phenomena known to complicate photon counting. Although accurately quantifying effective measurement noise may not be of primary interest in SPT studies, it may be used for calibrating statistically acceptable models when using the average measurement does not suffice. In addition to measurement noise, other dynamical parameters may often change over the course of a single trajectory. All 3D ARG3 trajectories illustrated by FIG. 3 were observed to have statistically significant smooth parameter changes in dynamical parameters governing particle motion. This may have important implications, for example, in regards to explaining one cause of anomalous diffusion, and also for tracking groups of particles in the cytoplasm where dynamical models with fixed parameters are often utilized.

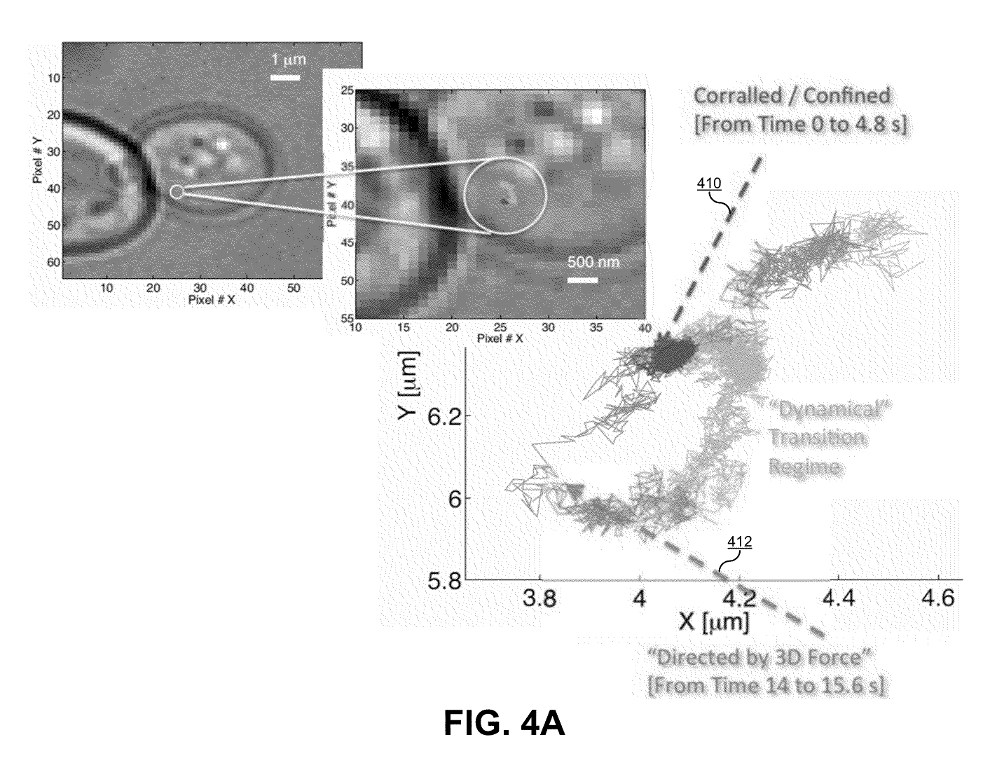

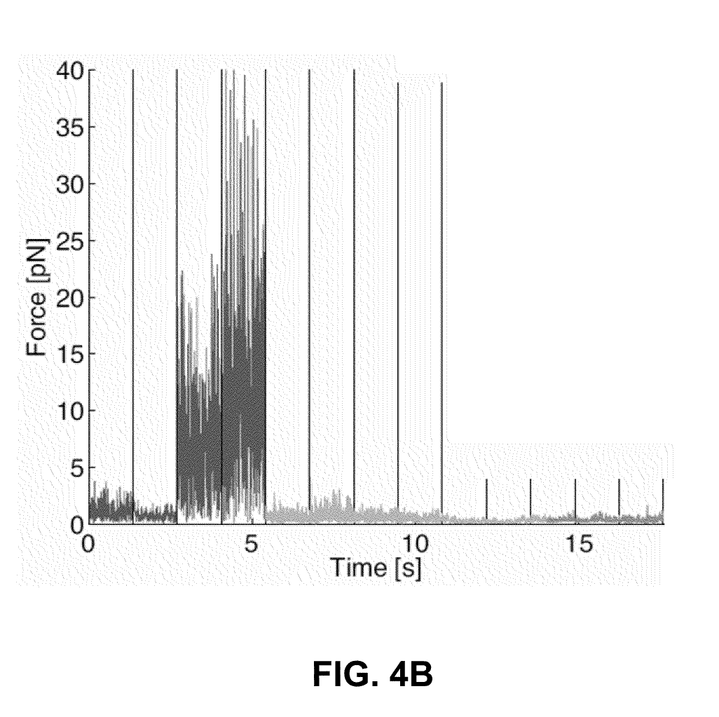

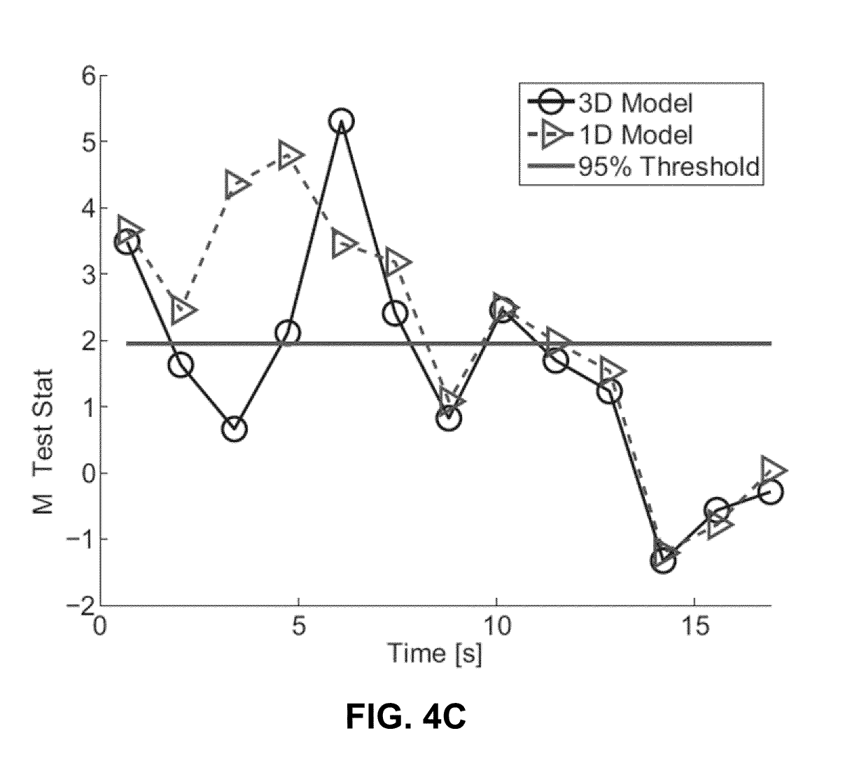

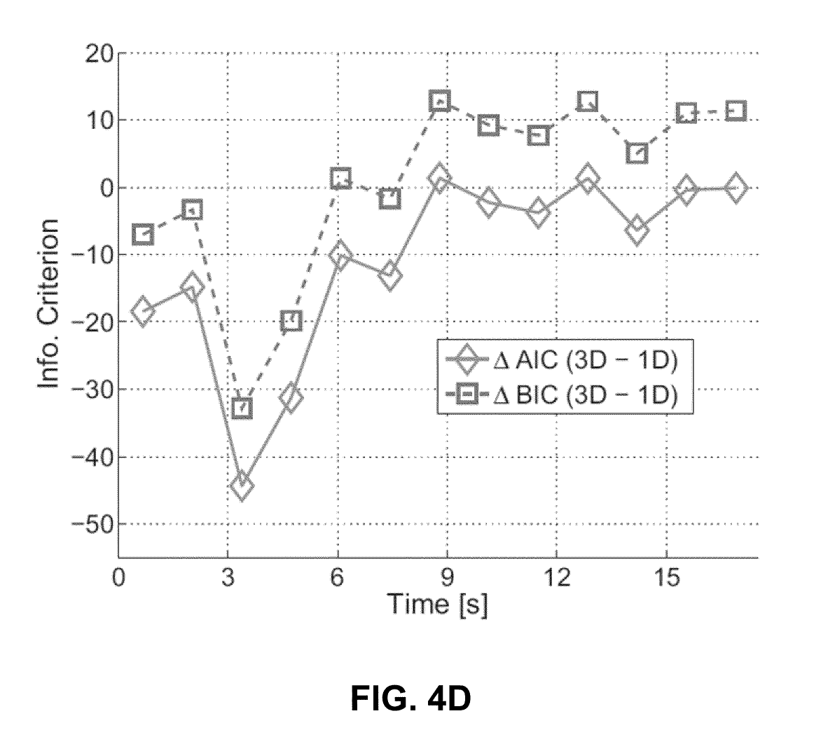

The next result demonstrates another case where a dynamical regime change was observed along a single 3D trajectory. However, this trajectory was flagged by the goodness of fit test as not being consistent with traditional SPT models. FIG. 4A illustrates the white light image of the cell containing the tagged particle. A magnification of the image is also shown the microscope images are magnified and the X-Y coordinates of the experimentally measured trajectory are shown. Region 410 shows where the particle was confined by large constraint forces. The inferred forces reached magnitude as high as 30pN for 1-1.5 second bursts. Region 412 is a dynamical regime encountered before the particle experiences a “3-D directed force” of region 414.

FIG. 4B illustrates a phase plot indicating the 2D trajectory of the DH-PSF midpoint measurements. The trajectory is divided by a regime labeling that was applied to the data after the implied force magnitudes were analyzed. The 3D force magnitude was inferred from K=13 windows. The window boundaries are shown at all micro-times by vertical lines in the bottom of the plot. The section just prior to t=5 s denotes the confined regime where the particle was observed to exhibit large bursts of force ranging from 1-30pN. It should be noted that the uncertainty in each force measurement was approximately 34.8% of the measured value.

It was also demonstrated that the force bursts were not overly dependent on the sampling parameter K (or W). Note that the elasticity inferred during the force burst (e.g., 650.4-975.6 pN/micron) is much larger than standard RNA elasticities that were observed using prior known methods, and that the size of the force magnitude is consistent with those forces studied via in vitro ribosome/mRNA studies. It was also quantitatively demonstrated that the 3D SDE model improves performance in terms of goodness-of-fit and model selection criteria, respectively.

FIG. 4C illustrates the goodness of fit test statistic, and FIG. 4D plots the AIC and BIC comparing a genuine 3D model to a 1D model. Here, lower values indicate better fits for both goodness of fit and model selection statistics. The trajectory strongly suggests constraint forces. The AIC and BIC model selection criteria verified that adding correlation between the effective forces governing the particle dynamics improves the fit. The experimental trajectory and effective forces imply the existence of a manifold on which the particle evolves. The SDE quantifies the strength of the tether to this manifold.

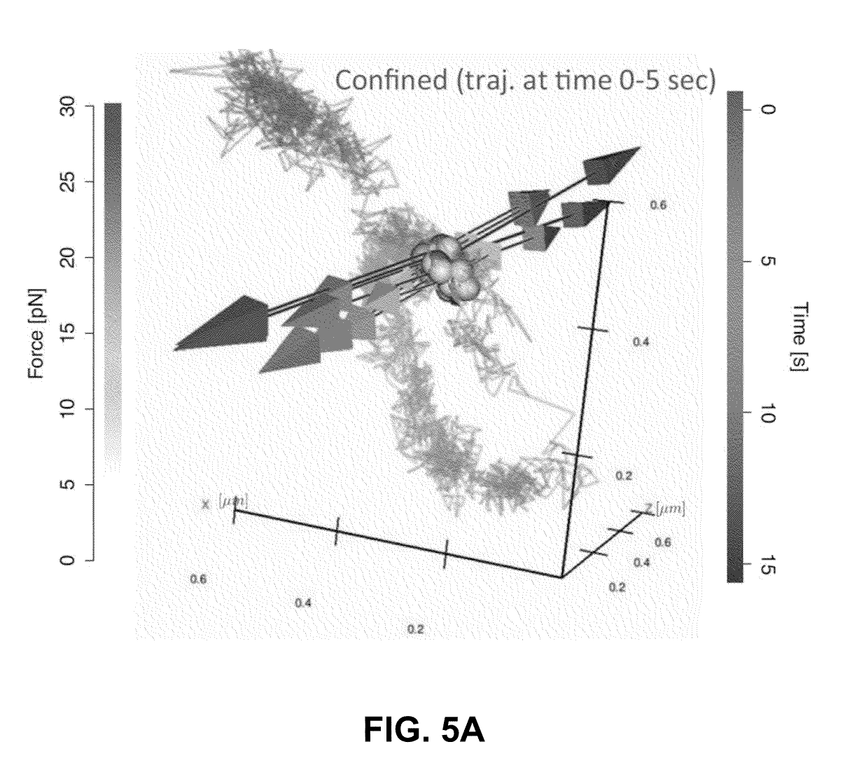

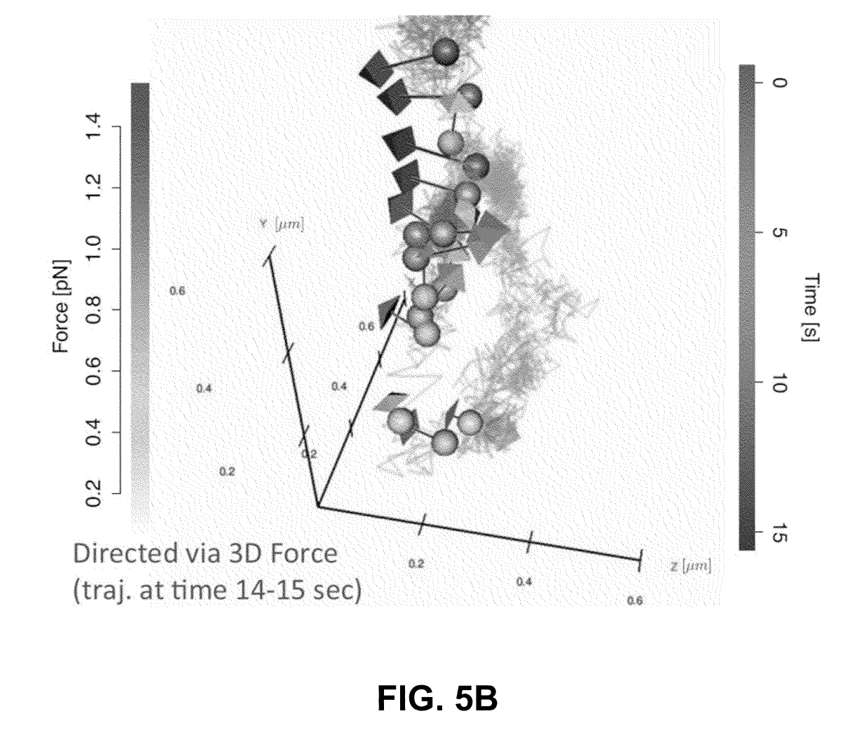

FIG. 5A illustrates a plot of the raw 3D trajectory as well as the inferred forces in the confined regime discussed above. The solid lines show the 3-D measurements and the spears and arrows denote the inferred 3-D force vectors. The plot in FIG. 5B is similar to that of FIG. 5A, but the forces correspond to those of the directed regime. Note how the trajectory traverses an apparent 2D “manifold” after it exits the confined regime. The manifold implied by the raw experimental data is likely due to an interaction of the tagged particle with an object in the cytoplasm. This statement is strengthened by the SDE goodness-of-fit and model selection analysis showing that the sequence of measurements is best explained by forces whose components are statistically dependent.

In the confined regime of this trajectory, the mRNA particle appears to be tightly bound to another molecule, and then engages in active transport. One interpretation of this observation may be that a protein involved with a mRNA-protein (mRNP) complex is binding to the tagged mRNA. The complex then attaches to a cytoskeletal track, such as a microtubule or actin cable. The mRNP is subsequently moved along the track by a molecular motor. Another, albeit more ambitious, interpretation of this data is that the observed phenomenon is a dynamical signature associated with the translation of mRNA by a ribosome. The large directed forces in the confined regime can be highly suggestive of the tagged particle being bound to another molecule in the cytoplasm (the highly directed forces are likely steric constraints). The force magnitudes inferred by the SDE are in the 1-30 pN range for bursts. This range can possibly be explained by ribosomal forces; however, these experiments were different in spirit. Specifically, the fluorescently tagged molecule is being passively observed in vivo, so directly comparing force magnitudes may not be straightforward. The subsequent rich 3D dynamics may possibly be explained by a ratcheted rotation of the ribosome head, followed by a release of the ribosome. In other words, this SDE analysis may have uncovered a SPT trajectory exhibiting a mRNA/ribosome interaction in vivo and quantified the associated forces. The ribosome interpretation may be ambitious, but the highly directed inferred force vectors are nonetheless useful in determining that the particle is interacting strongly with another object in the cytoplasm.

The implied SDE forces display a 3D pattern suggesting a directed transport mechanism in FIG. 5B. Typically, a mean square displacement analysis coupled with a large measured velocity characterizes directed motion. However, both the magnitude of velocity and duration of directed motion on cytoskeletal tracks are difficult to quantify at the single-molecule level. The use of inferred SDE forces evaluated at micro-times can help in providing another dynamical fingerprint of directed transport along a cytoskeletal track. Molecular motors are believed to shuttle mRNP complexes that are and are not asymmetrically localized in yeast. When a mRNP complex is moved by a motor along a track, a force must act tangential along the track in order for to observe “directed transport,” but other forces must also be involved. For example, a motor stalk must tether the cargo near the track. The force vectors observed in FIG. 5B are suggestive of both a classic directed force and a tethering force constraining the mRNP near a cytoskeletal track. The velocity of the directed transport observed in this trajectory reached an average value of 490 nm/s in the directed regime. This magnitude is not excessively large but coupled with the force vector magnitude and directionality (suggesting a tethering force), the possibility of the tagged mRNP being shuttled across the cytoskeletal highway seems more plausible. It is also worth noting that the fraction of trajectory segments identified to be undergoing “directed diffusion” (≈6.7%) and “static motion” (≈28.1%) is comparable to the fractions reported previously in the art.

### Example Method for Particle Tracking

In the previous sections, various embodiments of methods for tracking a molecule in a living cell have been discussed in great detail. This section outlines a general heuristic that may be used to track a particle, according to one exemplary embodiment. It will be understood that many of the details discussed in the previous section are not discussed specifically in this method for brevity. However, any and/or all of the details, models, methods, parameter, or equations can be used where appropriate in this method.

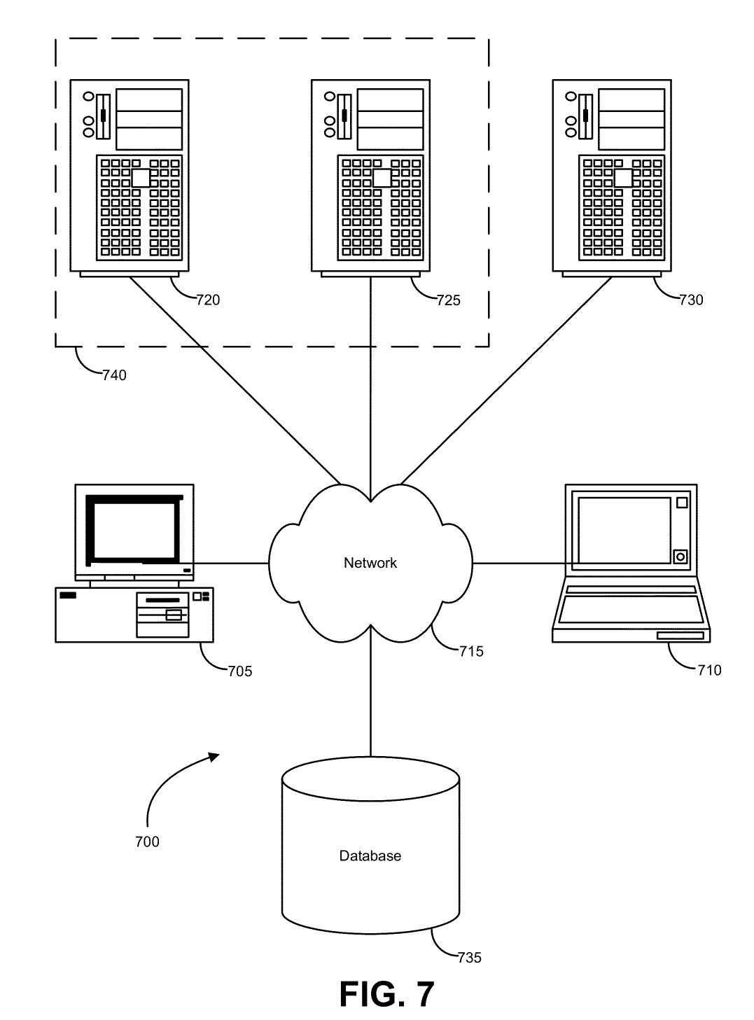

Each of the methods discussed below may be implemented in a computer system, such as computer system 700 of FIG. 7 (discussed further below). Additionally, the methods may be implemented by one or more processors that are configured to execute the steps of the method. The method steps may be stored in a memory communicatively coupled to and readable by the one or more processors, and may be embodied by a set of instructions. Such a set of instructions may be stored on a computer-readable medium. In one embodiment, a computer-readable medium may include a non-transient and/or tangible computer-readable medium.

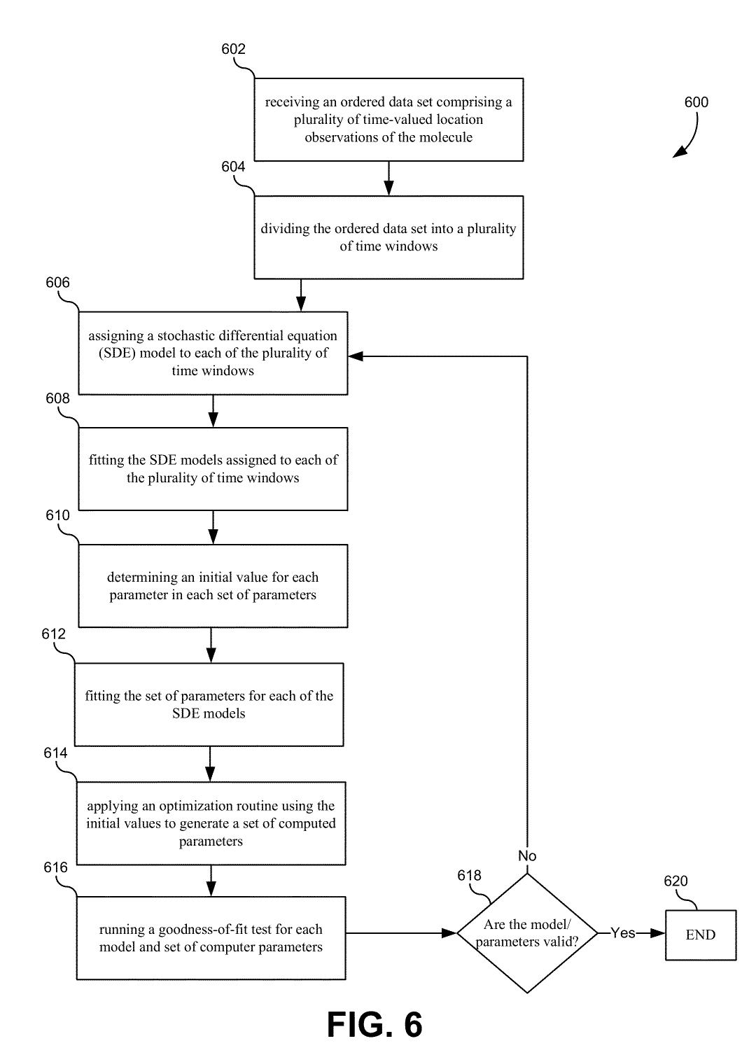

FIG. 6 illustrates a flowchart 600 of a method for tracking a tagged molecule in a living cell in two or three dimensions, according to one embodiment. The method may include receiving an ordered data set comprising a plurality of time-valued location observations of the molecule (602). In one embodiment, the time-valued location observations of the molecule may represent point spread functions derived from images of the molecule. Additionally, the molecule can be tagged such that the molecule emits a fluorescence signal associated with a slowly changing intensity.

The method may also include dividing the ordered data set into a plurality of time windows (604). In one embodiment, each of the plurality of time windows is the same size; however, in another embodiment, each of the plurality of time windows may have varying sizes. In one embodiment, the method may also detect the presence of non-linear or non-Markovian effects, wherein the power of detecting model misspecification is based on the window size. In this case, the method may further comprise dividing the ordered data set into a second plurality of time windows where at least some of the time windows have a smaller window size than the original plurality of time windows.

The method may additionally include assigning a stochastic differential equation (SDE) model to each of the plurality of time windows (606). In one embodiment, the SDE model assigned to a first time window may include a physically interpretable model, such as an overdamped Langevin equation. In another embodiment, the SDE model assigned to a second time window may comprise a more general nonlinear SDE model. In one embodiment, each of the SDE models may also comprise a set of parameters. Furthermore, each of the parameters may be associated with a physical characteristic of either the molecule or an environment inside the living cell. For example, one parameter may be associated with a diffusion coefficient. Another parameter may be associated with quantifying friction.

The method may further include fitting the SDE models assigned to each of the plurality of time windows (608). In one embodiment, one or more of the SDE models can be assigned using one or more likelihood-based techniques. These techniques may include any of those techniques described previously herein. In one embodiment, each of the time windows may have the same SDE model assigned. However, in another embodiment, time windows may have different SDE models assigned. The method may also include determining an initial value for each parameter in each set of parameters (610). Determining an initial value for each parameter has also been described extensively previously in this disclosure. This step (610) in the method may include any of those techniques previously described. Specific to one embodiment, the initial values may be close to the global optimum associated with a nonlinear MLE search.

The method may also include fitting the set of parameters for each of the SDE models (612). In one embodiment, the set of parameters may be fit using the nonlinear MLE search. The method may additionally include applying an optimization routine using the initial values to generate a set of computed parameters (614). In one embodiment, the optimization routine may include heuristics for inferring the global MLE optima. Furthermore, the optimization routine may include a nonlinear simplex search for determining the set of computed parameters.

The method may additionally include running a goodness-of-fit test for each model and set of computer parameters (616). In one embodiment, the goodness-of-fit test can also be used to help identify potential local minima. In other words, the SDE model for a time window may be valid; however, the optimization routine may have found parameters close to a local minima, rather than a global one. In one embodiment, the one or more goodness-of-fit tests may include a probability integral transformation (PIT).

The method may further include determining whether each of the computed parameters and/or SDE models are valid using the one or more of the goodness-of-fit tests (618). If the computer parameters and/or models are valid, then the models may be accepted and used to describe the motion of the molecule in each time window (620). On the other hand, if at least one of the models are rejected by the goodness-of-fit tests, then the method may reassign new SDE models to one or more of the time windows (606), and loop through the remaining steps of the method until all of the models are determined to be valid. In one particular embodiment where each time window has the same SDE model assigned, detecting at least one invalid SDE model may cause a new SDE model to be assigned to each window. Also, (not shown) if any of the computed parameters are determined to be invalid, the method may determine new initial values for each of the parameters (610). In one embodiment, the parameters for each time window are evaluated individually. Also, if one or more of the models are determined to be inconsistent with the experimental observations and therefore invalid because of nonlinear effects not accounted for in the local models, then the method may reassign new time windows (604) that are smaller than the original time windows to attempt to remove the nonlinear effect, and then re-execute the remaining steps of the method.

It should be appreciated that the specific steps illustrated in FIG. 6 provide particular methods of tracking a tagged molecule in a living cell in two or three dimensions according to various embodiments of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

### Hardware

Each of the embodiments disclosed herein may be implemented in a computer system. FIG. 7 is a block diagram illustrating components of an exemplary operating environment in which various embodiments of the present invention may be implemented. The system 700 can include one or more user computers 705, 710, which may be used to operate a client, whether a dedicated application, web browser, etc. The user computers 705, 710 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 705, 710 may also have any of a variety of applications, including one or more development systems, database client and/or server applications, and web browser applications. Alternatively, the user computers 705, 710 may be any other electronic device, such as a thin-client computer, Internet-enabled mobile telephone, and/or personal digital assistant, capable of communicating via a network (e.g., the network 715 described below) and/or displaying and navigating web pages or other types of electronic documents. Although the exemplary system 700 is shown with two user computers, any number of user computers may be supported.

In some embodiments, the system 700 may also include a network 715. The network may can be any type of network familiar to those skilled in the art that can support data communications using any of a variety of commercially-available protocols, including without limitation TCP/IP, SNA, IPX, AppleTalk, and the like. Merely by way of example, the network 715 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 720, 725, 730 which can be general purpose computers and/or specialized server computers (including, merely by way of example, PC servers, UNIX servers, mid-range servers, mainframe computers rack-mounted servers, etc.). One or more of the servers (e.g., 730) may be dedicated to running applications, such as a business application, a web server, application server, etc. Such servers may be used to process requests from user computers 705, 710. The applications can also include any number of applications for controlling access to resources of the servers 720, 725, 730.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 705, 710. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 705, 710.

In some embodiments, an application server may create web pages dynamically for displaying on an end-user (client) system. The web pages created by the web application server may be forwarded to a user computer 705 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 700 may also include one or more databases 735. The database(s) 735 may reside in a variety of locations. By way of example, a database 735 may reside on a storage medium local to (and/or resident in) one or more of the computers 705, 710, 715, 725, 730. Alternatively, it may be remote from any or all of the computers 705, 710, 715, 725, 730, and/or in communication (e.g., via the network 720) with one or more of these. In a particular set of embodiments, the database 735 may reside in a storage-area network (“SAN”) familiar to those skilled in the art. Similarly, any necessary files for performing the functions attributed to the computers 705, 710, 715, 725, 730 may be stored locally on the respective computer and/or remotely, as appropriate. In one set of embodiments, the database 735 may be a relational database, such as Oracle 10g, that is adapted to store, update, and retrieve data in response to SQL-formatted commands.

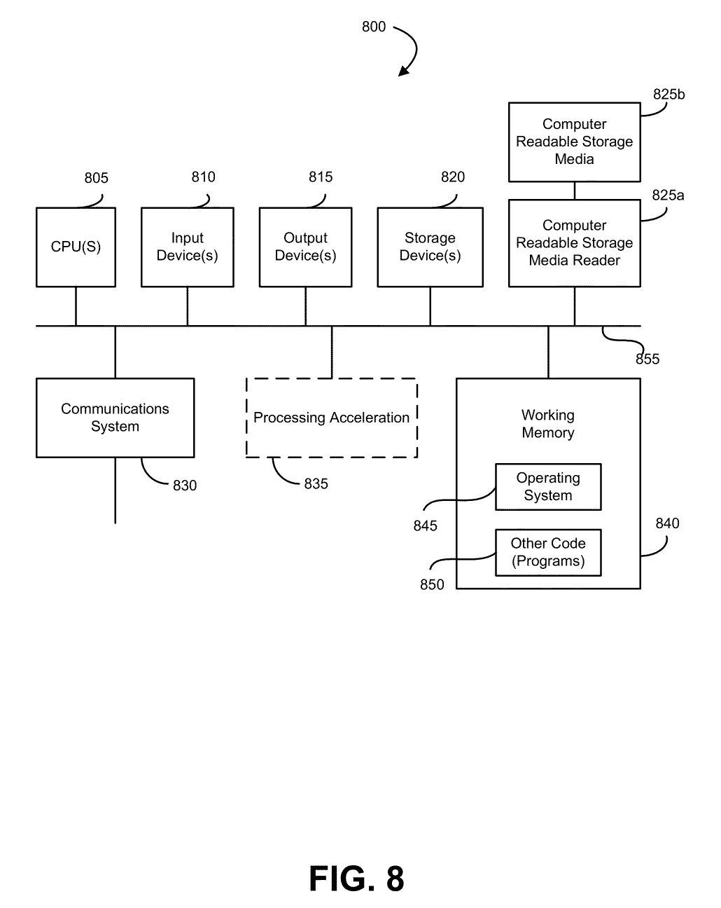

FIG. 8 illustrates an exemplary computer system 800, in which various embodiments of the present invention may be implemented. The system 800 may be used to implement any of the computer systems described above. The computer system 800 is shown comprising hardware elements that may be electrically coupled via a bus 855. The hardware elements may include one or more central processing units (CPUs) 805, one or more input devices 810 (e.g., a mouse, a keyboard, etc.), and one or more output devices 815 (e.g., a display device, a printer, etc.). The computer system 800 may also include one or more storage device 820. By way of example, storage device(s) 820 may be disk drives, optical storage devices, solid-state storage device such as a random access memory (“RAM”) and/or a read-only memory (“ROM”), which can be programmable, flash-updateable and/or the like.

The computer system 800 may additionally include a computer-readable storage media reader 825a, a communications system 830 (e.g., a modem, a network card (wireless or wired), an infra-red communication device, etc.), and working memory 840, which may include RAM and ROM devices as described above. In some embodiments, the computer system 800 may also include a processing acceleration unit 835, which can include a DSP, a special-purpose processor and/or the like.

The computer-readable storage media reader 825a can further be connected to a computer-readable storage medium 825b, together (and, optionally, in combination with storage device(s) 820) comprehensively representing remote, local, fixed, and/or removable storage devices plus storage media for temporarily and/or more permanently containing computer-readable information. The communications system 830 may permit data to be exchanged with the network 820 and/or any other computer described above with respect to the system 800.

The computer system 800 may also comprise software elements, shown as being currently located within a working memory 840, including an operating system 845 and/or other code 850, such as an application program (which may be a client application, web browser, mid-tier application, RDBMS, etc.). It should be appreciated that alternate embodiments of a computer system 800 may have numerous variations from that described above. For example, customized hardware might also be used and/or particular elements might be implemented in hardware, software (including portable software, such as applets), or both. Further, connection to other computing devices such as network input/output devices may be employed. Software of computer system 800 may include code 850 for implementing embodiments of the present invention as described herein.

Each step of the methods disclosed herein may be done automatically by the computer system, and/or may be provided as inputs and/or outputs to a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a Web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Therefore, it will be understood in light of this disclosure, that each step and each method described herein may be altered to include an input and output to and from a user, or may be done automatically by a computer system.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

1. A method of tracking a tagged molecule in a living cell in two or three dimensions, the method comprising:
receiving an ordered data set comprising a plurality of time-valued, two or three dimensional, location observations of the tagged molecule;
dividing the ordered data set into a plurality of time windows;
assigning a stochastic differential equation (SDE) model to each of the plurality of time windows, wherein each SDE model comprises a set of parameters;
fitting the SDE models assigned to each of the plurality of time windows using one or more likelihood-based techniques;
determining an initial value for each parameter in each set of parameters, wherein the initial values are determined in the absence of applied measurement forces on the tagged molecule by using:
an empirical covariance estimate from the plurality of time-valued location observations; and
an estimate of measurement noise;
fitting the set of parameters for each of the SDE models using a nonlinear maximum likelihood estimation (MLE) search;
applying an optimization routine using the initial values to generate a set of computed parameters;
determining whether each of the computed parameters are valid using one or more goodness-of-fit tests; and
determining whether each of the SDE models was valid based on the results of the goodness-of-fit tests, wherein each method step is performed using a computer system.

2. The method of claim 1 further comprising:
detecting the presence of model misspecification that is based on a window size of the plurality of time windows; and
dividing the ordered data set into a second plurality of time windows; wherein a second window size for the second plurality of time windows is different from the window size of the plurality of time windows.

3. The method of claim 1, wherein each parameter in each set of parameters is associated with a physical characteristic of either the molecule or an environment inside the living cell.

4. The method of claim 1, wherein the molecule is tagged such that the molecule emits a gradually changing fluorescent signature.

5. The method of claim 1 wherein:
the plurality of time windows comprises a first time window; and
the SDE assigned to the first time window comprises an overdamped Langevin equation.

6. The method of claim 1 wherein:
the plurality of time windows comprises a first time window; and
the SDE assigned to the first time window comprises a nonlinear SDE model.

7. The method of claim 1 wherein the one or more goodness-of-fit tests comprises a probability integral transformation (PIT).

8. The method of claim 1 wherein the optimization routine comprises:
heuristics for inferring the global MLE; and
a nonlinear simplex search for determining the set of computed parameters.

9. The method of claim 1 wherein the goodness-of-fit tests is used to identify potential local minima.

10. The method of claim 1 wherein:
the plurality of time windows comprises a first time window;
the computed parameters for the first time window are determined not to be valid; and
the method further comprises:
assigning a new SDE model to the first time window.

11. The method of claim 1 further comprising determining a trajectory of the molecule based on the computed parameters.

12. The method of claim 1 further comprising causing to be displayed on a display device, a 3D vector representation of forces affecting the motion of the molecule.

13. The method of claim 1 wherein the one or more goodness-of-fit tests are applied to each of an x, y, and z component of the molecule's position.

14. A system comprising:
one or more processors; and
a memory communicatively coupled with and readable by the one or more processors and having stored therein a sequence of instructions which, when executed by the one or more processors, cause the one or more processors to track a tagged molecule in a living cell in two or three dimensions by:
receiving an ordered data set comprising a plurality of time-valued, two or three dimensional, location observations of the tagged molecule;
dividing the ordered data set into a plurality of time windows;
assigning a stochastic differential equation (SDE) model to each of the plurality of time windows, wherein each SDE model comprises a set of parameters;
fitting the SDE models assigned to each of the plurality of time windows using one or more likelihood-based techniques;
determining an initial value for each parameter in each set of parameters, wherein the initial values are determined in the absence of applied measurement forces on the tagged molecule by using:
an empirical covariance estimate from the plurality of time-valued location observations; and
an estimate of measurement noise;
fitting the set of parameters for each of the SDE models using a nonlinear maximum likelihood estimation (MLE) search;
applying an optimization routine using the initial values to generate a set of computed parameters;
determining whether each of the computed parameters are valid using one or more goodness-of-fit tests; and
determining whether each of the SDE models was valid based on the results of the goodness-of-fit tests.

15. The system of claim 14, wherein, each parameter in each set of parameters is associated with a physical characteristic of either the molecule or an environment inside the living cell.

16. The system of claim 14, wherein the optimization routine comprises:
heuristics for inferring the global MLE; and
a nonlinear simplex search for determining the set of computed parameters.

17. The system of claim 14, wherein the sequence of instructions further cause the one or more processors to determine a trajectory of the molecule based on the computed parameters.

18. A non-transitory computer-readable memory having stored thereon a sequence of instructions which, when executed by one or more processors, causes the one or more processors to track a tagged molecule in a living cell in two or three dimensions by:
receiving an ordered data set comprising a plurality of time-valued, two or three dimensional, location observations of the tagged molecule;
dividing the ordered data set into a plurality of time windows;
assigning a stochastic differential equation (SDE) model to each of the plurality of time windows, wherein each SDE model comprises a set of parameters;
fitting the SDE models assigned to each of the plurality of time windows using one or more likelihood-based techniques;
determining an initial value for each parameter in each set of parameters, wherein the initial values are determined in the absence of applied measurement forces on the tagged molecule by using:
an empirical covariance estimate from the plurality of time-valued location observations; and
an estimate of measurement noise;
fitting the set of parameters for each of the SDE models using a nonlinear maximum likelihood estimation (MLE) search;
applying an optimization routine using the initial values to generate a set of computed parameters;
determining whether each of the computed parameters are valid using one or more goodness-of-fit tests; and
determining whether each of the SDE models was valid based on the results of the goodness-of-fit tests.

19. The non-transitory computer-readable medium of claim 18, wherein the sequence of instructions further cause the one or more processors to:
detect the presence of model misspecification that is based on a window size of the plurality of time windows; and
divide the ordered data set into a second plurality of time windows; wherein a second window size for the second plurality of time windows is different from the window size of the plurality of time windows.

20. The non-transitory computer-readable medium of claim 18, wherein the one or more goodness-of-fit tests are applied to each of an x, y, and z component of the molecule's position.
